(19) United States
(12) Patent Application Publication
(10) Pub. No.: US 2016/0044869 A1
(43) Pub. Date: Feb. 18, 2016

(54) Apparatus for Chopping and discharging Straw from a Combine Harvester

(71) Applicant: Dean Mayerle, Saskatoon (CA)

(72) Inventor: Dean Mayerle, Saskatoon (CA)

(21) Appl. No.: 14/824,521

(22) Filed: Aug. 12, 2015

Related U.S. Application Data
(60) Provisional application No. 62/036,199, filed on Aug. 12, 2014.

(51) Int. Cl. A01F 12/58; A01F 29/12; A01F 12/40

(52) U.S. Cl. CPC A01F 12/58; A01F 12/40; A01F 29/12

(57) ABSTRACT

In a combine harvester comprising a threshing rotor and an internal chopper or beater behind the threshing rotor feeding into a rear straw chopper and spreader through a distribution chamber there is provided a distribution assembly mounted rearwardly of the internal chopper or beater for controlling distribution of the materials transversely of the distribution chamber. The distribution assembly includes a pair of rearwardly extending fins which are moved by a control system for operating the fins to change the distribution at the rear of the combine harvester. The fins are carried on a mounting which is translated side to side and the fins are curved in a direction longitudinally of the direction of movement of the material from the discharge. The fins are controlled in response to a plurality of sensors at spaced positions across the distribution chamber and the sensors measure crop flow at the sensor by detecting impact of crop material on the sensor.

This application claims the benefit under 35 USC 119 (e) of Provisional Application 62/036,199 filed Aug. 12, 2014.

This invention relates to an apparatus for chopping and discharging straw from a combine harvester and in particular to a residue regulator for straw chopper spreading.

### BACKGROUND OF THE INVENTION

In U.S. Pat. No. 6,840,854 issued Jan. 11 2005 of Redekop is disclosed an apparatus for chopping and discharging straw from a combine harvester of the type which includes a plurality of blade members mounted on a hub for rotation about an axis of the hub with the blade members being arranged at spaced positions along the length of the hub substantially in radial planes of the hub so as to pass adjacent a plurality of axially spaced stationary blades again arranged in radial planes of the hub. The straw and other material discharged from the combine is fed into one side of the housing of the apparatus onto the hub and the material is carried around by the hub past the stationary blades in a chopping action. The material is then discharged from a discharge opening in the housing onto a tail board with spreading fins for spreading across the field.

Combine development in recent years have put greater demands on the straw choppers and chaff spreaders. The main reasons are:

Larger combines and larger cutting widths are creating higher flows of straw and chaff;

Wider cutting widths create more demanding spreading widths;

Reduced tilling practices have put more demand on even spreading of both straw and chaff;

Plant breeding has resulted in tougher straw, higher yields and more residue;

Grain is often ready for harvest while the straw remains green.

In addition the following problems can arise with existing technology:

When residue is not distributed evenly into a straw choppers by the threshing rotor(s) due to green, moist conditions it cannot be evenly distributed out of a chopper. The rise in popularity of the rotary threshing combine has increased the problems with chopping and evenly spreading residue.

Distribution performance in dry conditions is best achieved with a tailboard as it is more power efficient, cost efficient and easier to set, dust is best controlled. However when harvest conditions change the residue distribution in to the straw chopper from the grain separating rotor can dramatically change. In tough or moist straw conditions the residue coming out of the threshing rotor may not disperse as in dry conditions and may enter the straw chopping housing in streams at very localized lateral positions. A traditional straw chopper will then cut and disperse the straw only to a few fins on the tailboard thus leaving streaks of heavy residue in the field which causes very uneven distribution with problems for next year's planting or seeding operations.

A secondary problem arises because of the uneven distribution into the chopper, the cutting quality is dramatically diminished. Residue is passed through the chopper uncut because of the overloading of parts of the chopper. The rotating blades deflect and do not cut, and the stationary knifebar does not extend through the straw mat.

Powered rotating discs were developed to solve the distribution problem of the tailboards in these conditions. They do help, but if the stream of residue from the threshing rotor is not balanced side to side one of the rotating discs will get more material than the other resulting in uneven distribution. Powered rotating distributors do not in any way solve the cutting problem in the chopper.

### SUMMARY OF THE INVENTION

According to one aspect of the invention there is provided a combine harvester comprising:

a threshing rotor rotatable about an axis generally longitudinal of the combine harvester for separating straw and chaff from a crop material to be collected;

an internal chopper or beater rearward of the threshing rotor having a rear discharge for expelling the material into a distribution chamber for discharge from the combine;

a straw discharge apparatus for receiving the straw and/or chaff materials from the distribution chamber and for distributing the straw and/or chaff materials from the combine harvester;

a distribution assembly mounted immediately rearwardly of the internal chopper or beater for controlling distribution of the materials transversely of the distribution chamber;

and a control system for operating the distribution assembly to change the distribution of the combine harvester.

Preferably the distribution assembly comprises a housing having a feed opening into which straw and/or chaff can be fed from the distribution chamber, a chopping assembly mounted in the housing and comprising a hub member mounted for rotation about a longitudinal axis of the hub member and a plurality of blade members mounted on the hub member for rotation therewith about said axis for chopping the fed materials and accelerating the chopped materials for discharge, the housing having a discharge opening through which the chopped materials are discharged, the housing and the chopping assembly being arranged such that the materials enter into the feed opening and discharges as a stream of crop material extending across the width of the housing and chopping assembly, and a spreading device for receiving the stream of crop material from the housing and chopping assembly for spreading the crop material in the field.

Preferably the distribution assembly comprises a plurality of fins extending from the rear discharge of the internal chopper or beater rearwardly into the distribution chamber, the fins being spaced inwardly from side walls of the distribution chamber. However other arrangements can be used which cause a re-direction of the material from the internal chopper or beater to change the distribution, such as panels mounted on the side wall(s), chopper or beater floor, or rotor discharge.

Preferably the fins are adjustable simultaneously, although they may also be independently adjustable.

Preferably the fins are adjustable side to side either by pivoting about an upright hinge at the forward end of the fin or more preferably by being translated side to side on a common slide member.

Preferably the fins are curved in a direction longitudinally of the direction of movement of the material from the discharge and are inclined toward one side wall of the distribution chamber so as to direct the material in a direction opposite to the direction of rotation of the rotor so as to smoothly turn the material toward one side wall to increase the amount of material on that one side.

In some cases the control system is actuated under control of the operator of the combine harvester. In addition or alternatively the control system is actuated in response to a sensed condition of operation of the combine harvester. Thus the control system may be configured to detect operating conditions of the harvester 10, such as a slope of the field, contours of the field, a wind speed, a position of the harvester 10, an orientation of the harvester, a moisture in the air, a moisture level of the crop, an amount of crop provided to first and/or second inlet portions, an amount of crop distributed by the first and second spreaders when a powered rotary spreader is used.

However, most preferably, the control system is actuated in response to a measurement of the distribution of the materials across the distribution chamber. This can preferably be done by a plurality or row of sensors of crop flow at spaced positions across the distribution chamber for providing said measurement of the distribution of the materials across the distribution chamber.

Preferably the sensors measure crop flow at the sensor by detecting impact by crop on the sensor. However, the sensors may be electrical sensors, optical sensors, mechanical sensors, and so forth.

Preferably there is provided a control flap member arranged at a rear of the distribution chamber movable to direct the materials into the housing or along a path by-passing over the housing or a second path by-passing the housing in front of the housing. In these cases the sensors preferably are mounted on the flap member in a row across an underside.

Preferably the materials are distributed from the chopping assembly by a tailboard having rearwardly and outwardly extending fins. However as an alternative the materials may be distributed from the chopping assembly by a powered rotary spreader.

According to a second aspect of the invention there is provided a combine harvester comprising:

a threshing rotor rotatable about an axis generally longitudinal of the combine harvester for separating straw and chaff from a crop material to be collected;

an internal chopper or beater rearward of the threshing rotor having a rear discharge for expelling the material into a distribution chamber for discharge from the combine;

a distribution assembly mounted immediately rearwardly of the internal chopper or beater for controlling distribution of the materials transversely of the distribution chamber;

wherein the distribution assembly comprises at least one fin arranged to extend from the rear discharge of the internal chopper or beater rearwardly into the distribution chamber, the fin being spaced inwardly from side walls of the distribution chamber;

and a control system for operating the distribution assembly to change the distribution of the combine harvester.

According to a third aspect of the invention there is provided a combine harvester comprising:

a threshing rotor rotatable about an axis generally longitudinal of the combine harvester for separating straw and chaff from a crop material to be collected;

an internal chopper or beater rearward of the threshing rotor having a rear discharge for expelling the material into a distribution chamber for discharge from the combine;

a distribution assembly mounted immediately rearwardly of the internal chopper or beater for controlling distribution of the materials transversely of the distribution chamber;

at least one sensor of crop flow at a position across the distribution chamber for providing a measurement of the distribution of the materials across the distribution chamber;

and a control system responsive to said at least one sensor for operating the distribution assembly to change the distribution.

One or more of the following objectives may be obtained by the arrangement as described in detail hereinafter:

A solution where the distribution from the threshing rotor into the chopping rotor or distributor if a chopping rotor or beater is internally mounted can be remotely changed based on sensed conditions;

Enhanced cutting because of even distribution into the straw chopper;

Enhanced spreading and even distribution onto the field because of even distribution into the straw chopper;

A feedback system to adjust deflectors to provide the operator feedback to make the adjustment or an automated system to provide adjustment.

### BRIEF DESCRIPTION OF THE DRAWINGS

One embodiment of the invention will now be described in conjunction with the accompanying drawings in which:

FIG. 1 is an isometric view of the operating components of a rotary combine with all covers omitted and showing the apparatus according to the present invention installed in the combine.

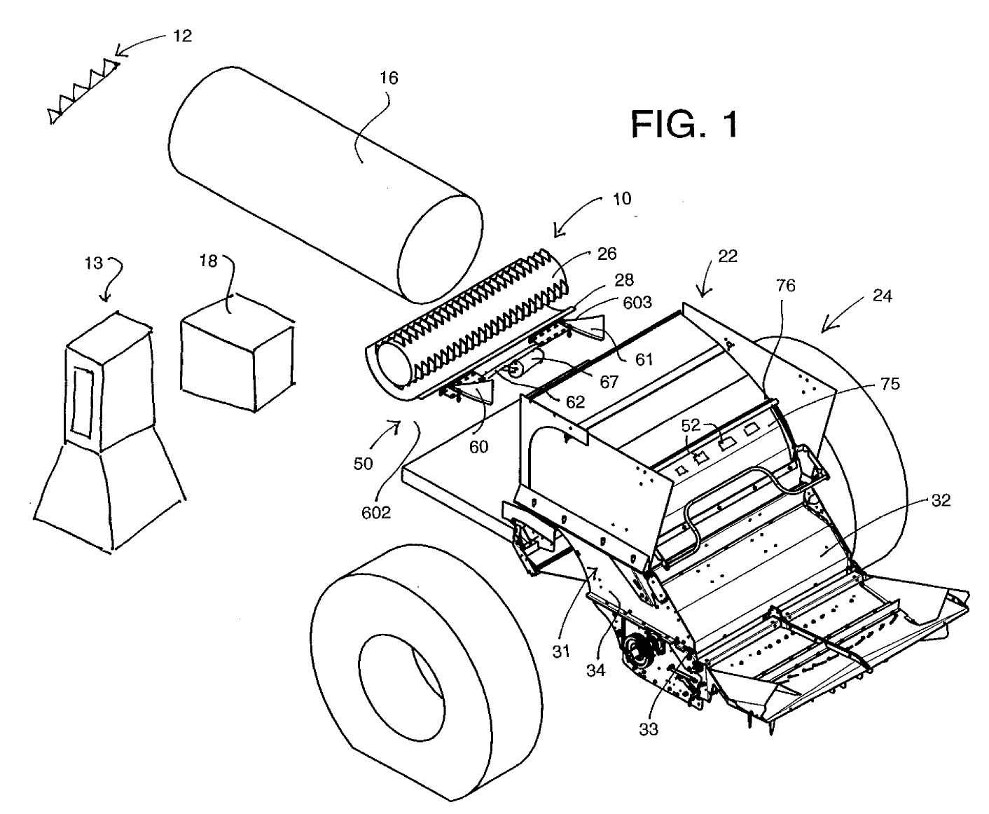

FIG. 2 is a top plan view of the components of FIG. 1.

FIG. 3 is a side elevational view of the components of FIG. 1.

FIG. 4 is an isometric view only of the internal chopper or beater and distribution adjustment system of FIG. 1.

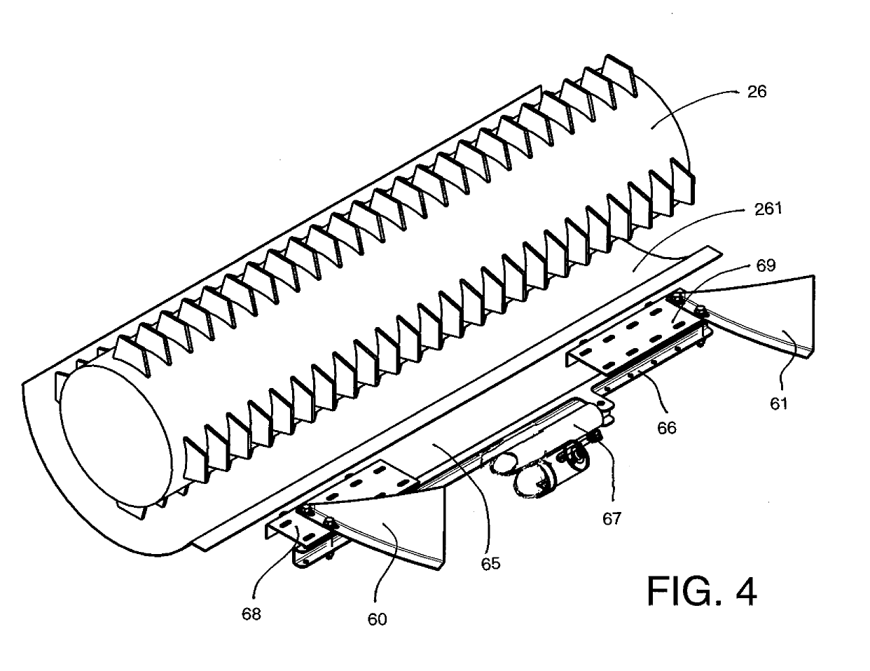

FIG. 5 is an isometric view from the rear of the components of FIG. 1.

FIG. 6 is a cross-sectional view similar to that of FIG. 3 on an enlarged scale.

In the drawings like characters of reference indicate corresponding parts in the different figures.

### DETAILED DESCRIPTION

The harvesting process begins with the harvester 10 using a cutting assembly 12 to remove plants from the field. An operator of the harvester 10 may be seated in a cab 13, and the operator may monitor the operation of the cutting assembly 12 and other systems of the harvester 10. After removing the plants, the harvester 10 transports the plants to a rotor 16. The rotor 16 rotates to separate the grain of the plants from other materials particularly straw and chaff. Specifically, the rotor 16 has multiple projections on its surface that interact with the plants to facilitate separation of the grain from the other materials. Grain is directed from the rotor 16 toward a cleaning system 18. The cleaning system 18 is configured to further separate the grain from the other materials. The other material is directed toward a distribution chamber 22, which connects to a spreader system 24 for distribution through a field.

The other material is directed toward a chopper or beater 26, which receives other material that has been removed from the field by the harvester 10. The chopper or beater 26 is configured to chop the other materials particularly the straw to facilitate distribution of smaller pieces of agricultural material across the field. Moreover, the chopper or beater 26 provides the other materials to the distribution chamber 22 in an air stream carrying the material rearwardly. Accordingly, the material is directed through the distribution chamber 22, as illustrated by arrow 28. The material is directed from the distribution chamber 22 toward an opening 30 in the spreader system 24. Thereafter, the spreader system 24 distributes the material across the field.

The arrangement described herein can be used with a rotary spreader of the type generally shown in U.S. Pat. No. 6,663,485 assigned to Claas which disclosed the first power spreader brought to the market which has a discharge chute of chopper parallel with the spreader or in U.S. Pat. No. 7,331,855 assigned to Deere which disclosed a further powered spreader.

However the arrangement is particularly effective with the chopper and tailboard arrangement shown and described hereinafter. The construction shown in U.S. application Ser. No. 14/801,168 filed Jul. 16, 2015 which corresponds to Canadian application 2,______ filed on the same date, the disclosure of which is incorporated herein by reference, can also be used which provides a combination of a chopper and tailboard arrangement together with a rotary type spreader of the above type.

The chopper and discharge arrangement shown in the Figures is very similar to that from the prior patents of Redekop which are U.S. Pat. Nos. 5,232,405 and 5,482,508.

The apparatus which is basically as shown in U.S. Pat. No. 6,840,854 issued Jan. 11 2005 of Redekop therefore comprises a housing 31 defined by a top wall 32, a bottom wall 33 and two end walls 34. The end walls 34 include attachment means schematically for attachment of the housing to the outlet of a combine harvester for discharge of straw and possibly chaff from the combine harvester into an inlet opening 30 of the housing 31. The bottom wall 33 defines a semi-cylindrical portion extending from the inlet 30 to an outlet 36 through which chopped straw and air is discharged at relatively high velocity for spreading across the field or for transportation into a container.

Within the housing is mounted a hub 37 which is carried on suitable bearings (not shown) for rotation about a hub axis at a center of the housing so that blade members 39 carried by the hub sweep around within the housing to entrap straw fed through the inlet 30 and to carry the straw and air past stationary blades 38 for chopping and for discharge through the outlet 16. The stationary blades 38 are mounted on the housing at a position approximately midway between the inlet 30 and the outlet 36 so that the blade members 39 sweep between the stationary blades in a cutting action.

The hub 37 carries a plurality of lugs 40 at angularly and axially spaced positions therealong with each lug mounting a pair of blade members for pivotal movement of the blade members about a pin parallel to the hub axis.

Each stationary blade is thus swept by the blade members once for each rotation of the hub with some of the stationary blades being swept at each of the four 90° positions of rotation of the hub.

In this arrangement of the chopper, there is provided three sections of the chopper assembly including a first fan section 41 at one end of the hub 37 and the second fan section 42 at the other end of the hub 37. In-between the two narrow fan sections is defined a center section 43 which provides the whole of the cutting action.

Within the center section all or substantially all of the blades are cutting blades with the cutting edge lying in a radial plane of the axis. The blades are preferably of the conventional flat blade type with a leading a trailing chamfered edge, although paddle blades as shown in U.S. Pat. No. 5,482,508 or wing blades shown in U.S. Pat. No. 7,104,883 may be used. Thus each of the two flail blades 21A in the center section can pass closely on either side of a respective one of the stationary blades. Thus the stationary blades can be spaced by a distance which is just sufficient to allow the passage there between of a flat cutting blade 39.

In the fan sections 41 and 42, there is provided a ring which is mounted on the hub 37 at a respective end of the hub. The ring thus surrounds the cylindrical wall of the hub and stands outwardly therefrom just beyond the end of the center section defined by the stationary blades and the blades 39 carried on the hub.

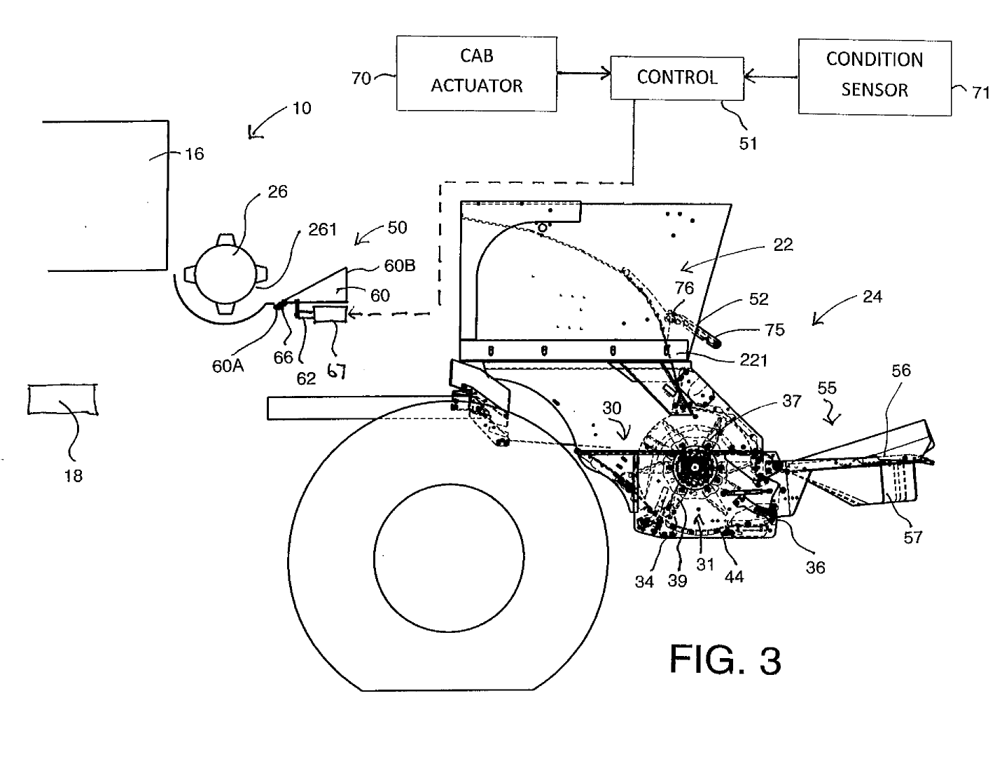

The rings each carry a plurality of fan blades 44 at spaced positions around the ring. The fan blades 44 are arranged thus so that each follow directly behind the next at the same axial location and there is no staggering of the fan blades 44. There are six such fan blades as shown in FIG. 3 so that the spacing between them angularly of the hub is reduced relative to the 90 degree spacing of the stationary blades.

Each of the fan blades 44 is bent with a fan blade portion so that each of the fan blades is of the shape shown in FIG. 3 of the U.S. Pat. No. 5,482,508 of Redekop. However the fan blades 44 do not necessarily have a sharp and leading edge since there is intended to be no cutting action in the fan section. Thus the fan blades are spaced from the end most stationary blade so that in effect no cutting action occurs in this section.

The bent fan blade portion stands outwardly to one side of the flat plate portion of the fan blade. The fan blade portion which is bent at right angles to the main body of the fan blade is maximised in dimension so that it may be rectangular. This large blade area together with the presence of the six blades provides a total fan blade area of 36 square inches which generates a significant air flow.

There is no baffle or other elements within the housing or on the chopper assembly to prevent air flow or material flow axially between the center section and the fan sections. The mounting ring 33 is only slightly greater in dimension than the hub so that it does not significantly interfere with the air flow between the hub and the housing since the majority of the air flow is around the outside of the housing where the fan blades are at their most effective.

The fan blade portion is inclined forwardly and outwardly so that at a regularly outer position toward the outer end of each fan blade the fan blade portion is angularly advanced relative to its position closer to the axis of the hub. This incline outwardly and forwardly significantly increases the air flow effect driving the air in the greater volume and at higher speed radially from the fan section and outwardly of the exit 16.

Preferably the fan section comprises only a single row of the six fan blades but in some cases an additional row or rows may be provided although this is not preferred. The fan blades are arranged immediately adjacent the end walls 13 so that they take up minimum space at the end of the chopper assembly. It will be appreciated that the intention is to provide maximum air flow in the fan sections while taking up minimum dimensions so that the maximised chopping effect to provide shortest material is achieved within the center section using the flat blades.

Just at the fan section, the housing provides a cover wall 45 which is a semi-cylindrical narrow wall having an inner edge at the intersection between the center section and the fan section and an outer edge abutting or attached to the outer wall. This cover panel thus reduces the amount of feed material which enters the fan section although of course this is not precluded in view of the fact that the material can flow axially from a position at the flat blades into the fan section due to the tendency for the fan section to draw air axially outwardly at the inlet and to drive air axially inwardly at the outlet.

In operation it has been found that the very high velocity of air from the fan section exiting radially outwardly from the exit discharge 16 occurs not only at the fan section but also extends partly into the width of the center section so that approximately 12 to 15 inches of the center section has a velocity at the exit which can be greater than 75 ft/s.

The above arrangement of chopper is one example only of arrangements which can be used herein.

The apparatus of the present invention when used with the combine harvester above includes the spreading device 24 and a distribution assembly 50 and a control unit 51 for the assembly 50 together with sensors 52.

The apparatus is arranged to be mounted at the rear discharge 221 of the chamber 22 of the combine harvester 10 and is arranged for receiving the straw and/or chaff materials from the combine harvester and for discharging the materials from the combine harvester.

The combine harvester comprises the threshing rotor 16 and the internal chopper or beater 26 rearward of the threshing rotor 16 where the internal chopper or beater has a rear discharge 261 for expelling the material into the distribution chamber 22 for discharge from the combine by the spreader system 24.

The spreader system 24 includes the housing 31 having the feed opening 30 into which straw and/or chaff is fed from the chamber 22. The apparatus further includes the chopping assembly mounted in the housing 31 and comprising the hub member 37 mounted for rotation about a longitudinal axis of the hub member and a plurality of blade members 39 mounted on the hub member 37 for rotation about the axis for chopping the fed materials and accelerating the chopped materials for discharge.

The housing and the chopping assembly are arranged such that the materials enter into the feed opening 30 as a stream across the full width and discharges as a stream of crop material extending across the width of the housing and chopping assembly at the discharge 36.

In this embodiment there is provided a spreading device 55 in the form of a tailboard 56 with rearwardly and outwardly extending fins 57 underneath the board 56 for receiving the stream of crop material from the housing 31 and chopping assembly for spreading the crop material in the field.

The distribution assembly 50 comprises a pair of fins 60 and 61 carried on a common support 62 at a position immediately rearwardly of the discharge 261 of the internal chopper or beater 26 for controlling distribution of the materials from the internal chopper or beater 26 in a direction transversely of the feed opening as the material moves rearwardly into the chamber 22. The control system 51 acts to control the distribution assembly 50 defined by the fins 60, 61 to change the distribution during operation of the combine harvester.

The generally triangular fins 60, 61 stand upright so as to engage the crop material at upstanding sides of the fins. The fins diverge from an entry or leading apex 60A to a trailing rear edge 60B. The fins extend from the rear discharge 261 of the internal chopper or beater 26 rearwardly toward or into the distribution chamber 22, with the fins being spaced apart by a central space 601 and spaced inwardly from side walls of the distribution chamber by spacing 602 and 603.

The fins are carried on spaced brackets 65 attached to the structure at the outlet 261 and the fins are adjustable simultaneously side to side on a rod 66 movable transversely of the flow of material by an actuator 67. Thus both fins move simultaneously in their adjustment movement and move closer to one side or other of the chamber 22.

As an alternative, pivotal adjustment about an upstanding pivot axis of the fins is also possible. The number fins may also be increased in some cases. The rod 66 carries a pair of perforated supports 68, 69 defining selectable holes by which the position of the fins relative to the rod 66 can be adjusted so as to move the fins closer to or further from the sides 222 and 223 of the chamber 22.

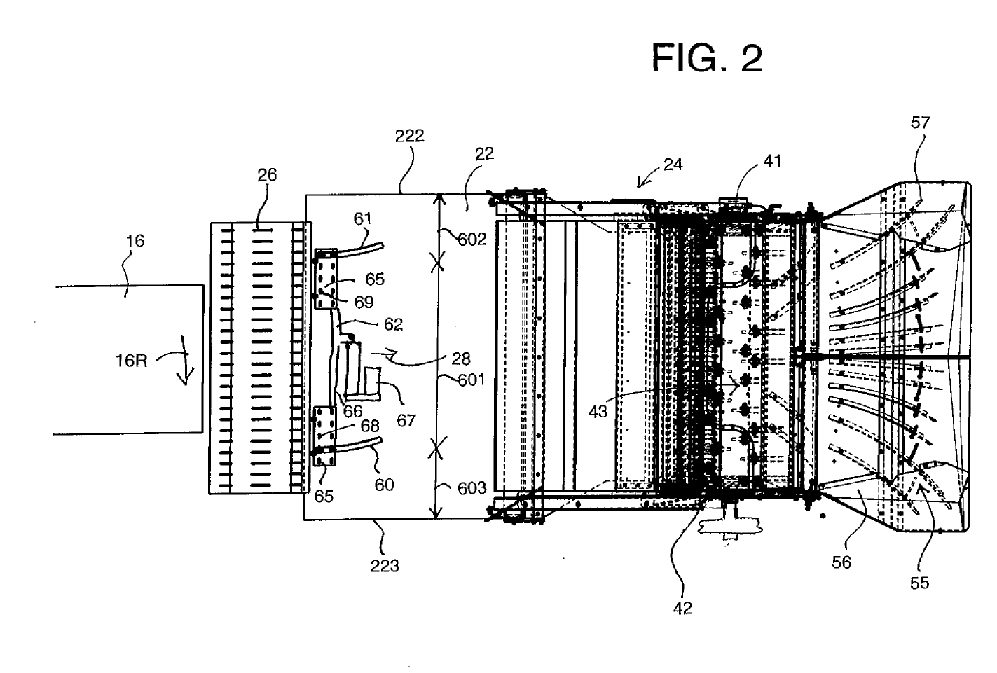

As best shown in FIG. 2, the fins 60, 61 are curved in a direction longitudinally of the direction of movement of the material from the discharge and are inclined toward one side wall 222 of the distribution chamber so as to direct the material in a direction opposite to the direction of rotation 16R of the bottom wall of the rotor 16 so as to counteract any tendency of the material to predominantly collect at the side wall 223.

The control system 51 can have a number of inputs allowing it to be controlled so that it is actuated under control of the operator of the combine harvester by a manually operable actuator 70 and also actuated in response to a sensed condition of operation of the combine harvester as indicated at 71.

However primarily the control system 51 is actuated in response to a measurement of the distribution of the materials across the distribution chamber by a plurality of sensors 52 of crop flow at spaced positions across the distribution chamber for providing the measurement of the distribution of the materials across the distribution chamber.

Typically as one example, the sensors 52 are acoustic so that straw and residue impacts a membrane of the acoustic sensor causing a small pulse of sound. Those analog audio pulses are converted into digital signals that are sent to the control unit 51. The control unit 51 calculates the signals and determines the distribution of the residue and provides feedback to either the operator or directly to the adjustment unit though the actuator 67.

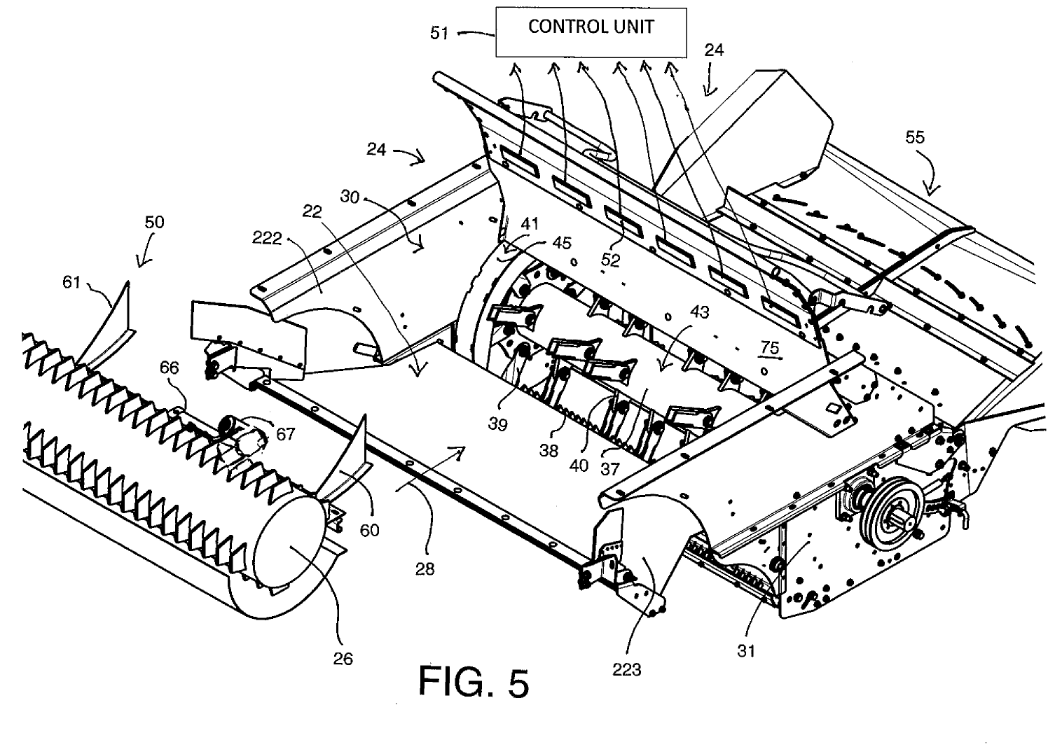

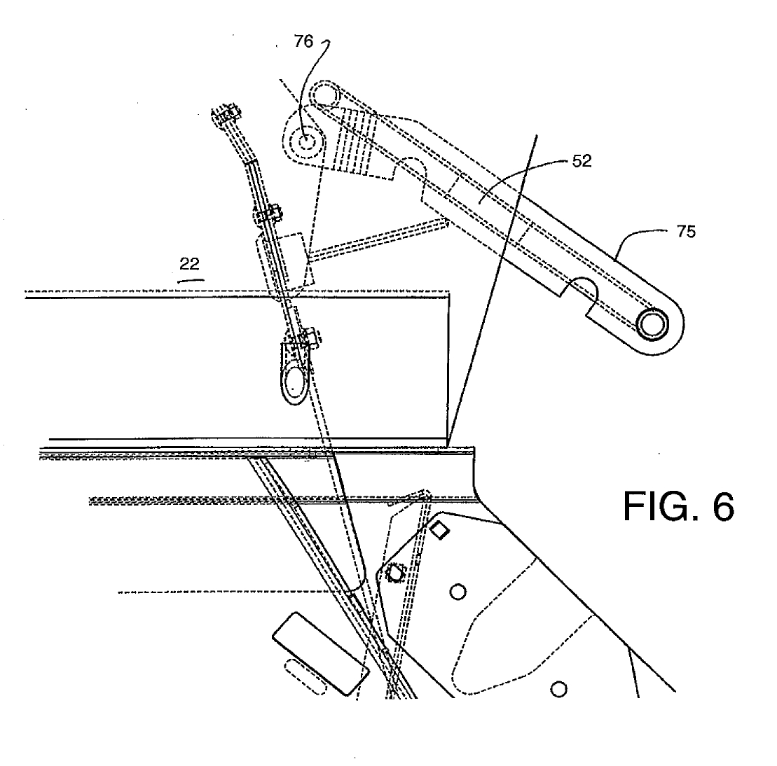

The sensors 52 are mounted on a control flap member 75 arranged, as best shown in FIG. 6, at a rear of the distribution chamber 22 movable forwards and rearwards on a top pivot 76 between three positions. Thus in a center position, shown in FIG. 5, the flap 75 acts to turn the material downwardly as it flows over the underside of the flap to direct the materials into the housing 31 for chopping. In a rearward position shown in FIGS. 3 and 6 the crop material again runs over the underside of the flap 75 but enters a path over the top of the housing by-passing the housing. In some cases a forward position (not shown) of the flap can be provided which acts to turn the cop material downwardly in front of the housing by-passing the housing. In all cases the sensors 52 act to detect the amount of crop flow at the sensor concerned which information is provided to the control 51 to operate the actuator 67 to move the fins toward one side or the other of the chamber 22 to increase the crop flow to the side required to balance the flow into a smooth constant flow across the width of the flap 75.

Thus the materials are, in the center position of the flap 75, distributed smoothly into the inlet of the chopping assembly and exit from the chopping assembly onto the tailboard 56 to be symmetrically distributed by the rearwardly and outwardly extending fins 57.

In some cases the tailboard can be replaced by the powered rotary spreader of the type described above so that the materials are distributed from the chopping assembly by the powered rotary spreader but again the balanced flow into the chopper assembly ensures the best cutting action and supplies the material symmetrically to the two rotors of the spreader.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A combine harvester comprising:
a threshing rotor rotatable about an axis generally longitudinal of the combine harvester for separating straw and chaff from a crop material to be collected;
an internal chopper or beater rearward of the threshing rotor having a rear discharge for expelling the material into a distribution chamber for discharge from the combine harvester;
a straw discharge apparatus for receiving the straw and/or chaff materials from the distribution chamber and for distributing the straw and/or chaff materials from the combine harvester;
a distribution assembly mounted immediately rearwardly of the internal chopper or beater for controlling distribution of the materials transversely of the distribution chamber;
and a control system for operating the distribution assembly to change the distribution of the combine harvester.

2. The combine harvester according to claim 1 wherein the distribution assembly comprises a plurality of fins arranged to extend from the rear discharge of the internal chopper or beater rearwardly into the distribution chamber, the fins being spaced inwardly from side walls of the distribution chamber.

3. The combine harvester according to claim 2 wherein the fins are adjustable simultaneously.

4. The combine harvester according to claim 2 wherein the fins are adjustable side to side.

5. The combine harvester according to claim 2 wherein the fins are curved in a direction longitudinally of the direction of movement of the material from the discharge.

6. The combine harvester according to claim 2 wherein the fins are inclined toward one side wall of the distribution chamber so as to direct the material in a direction opposite to the direction of rotation of the threshing rotor.

7. The combine harvester according to claim 1 wherein the control system includes a manual control element under control of an operating person of the combine harvester.

8. The combine harvester according to claim 1 wherein the control system is actuated in response to a sensed condition of operation of the combine harvester.

9. The combine harvester according to claim 1 wherein the control system is actuated in response to a measurement of the distribution of the materials across the distribution chamber.

10. The combine harvester according to claim 9 wherein there is provided a plurality of sensors of crop flow at spaced positions across the distribution chamber for providing said measurement of the distribution of the materials across the distribution chamber.

11. The combine harvester according to claim 10 wherein the sensors measure crop flow at the sensor by sensing impact of the crop material on the sensor.

12. The combine harvester according to claim 10 wherein there is provided a control flap member arranged at a rear of the distribution chamber movable to direct the materials into the housing or along a path by-passing the housing and wherein the sensors are mounted on the flap member.

13. The combine harvester according to claim 1 wherein the distribution assembly comprises a housing having a feed opening into which straw and/or chaff can be fed from the distribution chamber, a chopping assembly mounted in the housing and comprising a hub member mounted for rotation about a longitudinal axis of the hub member and a plurality of blade members mounted on the hub member for rotation therewith about said axis for chopping the fed materials and accelerating the chopped materials for discharge, the housing having a discharge opening through which the chopped materials are discharged, the housing and the chopping assembly being arranged such that the materials enter into the feed opening and discharges as a stream of crop material extending across the width of the housing and chopping assembly, and a spreading device for receiving the stream of crop material from the housing and chopping assembly for spreading the crop material in the field.

14. A combine harvester comprising:
a threshing rotor rotatable about an axis generally longitudinal of the combine harvester for separating straw and chaff from a crop material to be collected;
an internal chopper or beater rearward of the threshing rotor having a rear discharge for expelling the material into a distribution chamber for discharge from the combine;
a distribution assembly mounted immediately rearwardly of the internal chopper or beater for controlling distribution of the materials transversely of the distribution chamber;
wherein the distribution assembly comprises at least one fin arranged to extend from the rear discharge of the internal chopper or beater rearwardly into the distribution chamber, the fin being spaced inwardly from side walls of the distribution chamber;
and a control system for operating the distribution assembly to change the distribution of the combine harvester.

15. The combine harvester according to claim 14 wherein said at least one fin is adjustable side to side.

16. The combine harvester according to claim 14 wherein said at least one fin has a mounting which is translated side to side.

17. The combine harvester according to claim 14 wherein said at least one fin is curved in a direction longitudinally of the direction of movement of the material from the discharge.

18. A combine harvester comprising:
a threshing rotor rotatable about an axis generally longitudinal of the combine harvester for separating straw and chaff from a crop material to be collected;
an internal chopper or beater rearward of the threshing rotor having a rear discharge for expelling the material into a distribution chamber for discharge from the combine;
a distribution assembly mounted immediately rearwardly of the internal chopper or beater for controlling distribution of the materials transversely of the distribution chamber;
at least one sensor of crop flow at a position across the distribution chamber for providing a measurement of the distribution of the materials across the distribution chamber;
and a control system responsive to said at least one sensor for operating the distribution assembly to change the distribution.

19. The combine harvester according to claim 18 wherein there is a plurality of sensors at spaced positions across the distribution chamber and the sensors measure crop flow at the sensor by detecting impact of crop material on the sensor.

20. The combine harvester according to claim 18 wherein the distribution assembly comprises a plurality of fins arranged to extend from the rear discharge of the internal chopper or beater rearwardly into the distribution chamber, the fins being spaced inwardly from side walls of the distribution chamber.
